(19) United States
(12) Patent Application Publication
(10) Pub. No.: US 2008/0083378 A1
(43) Pub. Date: Apr. 10, 2008

(54) Pet exercise toy

(76) Inventor: Roger Pearce, Atlanta, GA (US)

Correspondence Address: WEATHERLY KERVEN & SEIGEL LLC, 115 PERIMETER CENTER PLACE, SUITE 1082, ATLANTA, GA, 30346-1245, US

(21) Appl. No.: 11/539,690

(22) Filed: Oct. 9, 2006

(51) Int. Cl. A01K 29/00

(52) U.S. Cl. 119/707

(57) ABSTRACT

The invention relates to a pet toy that may be filled with food or scented material to attract and maintain the animal's interest while the pet tries to extract the material contained inside. The toy is preferably made with two nested housings with each housing containing one or more holes in the sidewall. Some of the holes in the housings may be adjustably aligned to create a opening in the side wall of the toy that permits materials inside the toy to fall out. The space between the housings is configured to trap crumbs or other particulate material that might create an undesirable mess if allowed to fall out of the toy.

### I. BACKGROUND OF THE INVENTION

The present invention relates to pet toys. More particularly, it relates to toys that contain and dispense treats or other materials of interest to a pet when a pet plays with the toy.

It is widely known that pets like to play with various toys. Pet owners typically prefer toys that will retain a pet's interest and concentration over some period of time. Additionally, toys that occupy pets without requiring interaction from the pet owner are highly favored. Such toys can be left with the pet when the owner isn't present to keep the pet occupied and reduce the pet's boredom and separation anxiety, which may prevent misbehavior by the pet. However, most toys either provide insufficient stimulation or are too repetitive so that the pet is quickly bored of the toy.

It is generally accepted that the more stimulating a toy is, the greater the probability that the pet will continue to play with the toy for extended periods of time. In addition, toys that challenge the pet with non-repetitive challenges keep the pet's interest longer. As such, a need exists for a toy that stimulates as many of the pet's senses as possible while presenting a non-repetitive challenge to the pet.

### II. SUMMARY OF THE INVENTION

The inventor describes a toy that provides a high degree of stimulation in a non-repetitive manner that captures and holds a pet's interest over extended periods of time. The toy generally includes two nested cylindrical housings with the inner housing containing treats and the wall of the housings including at least one dispensing opening. The invention provides sensory stimulation for a pet's five major senses of sight, sound, smell, touch, and taste. By way of example, the pet can: see treats inside the toy when made of transparent material, hear treats rattling around inside the toy, smell treats through holes in the toy, feel the toy as the pet manipulates it, and taste the treats that fall from a dispensing opening in the toy.

The pet toy challenges the pet in varying ways because the user may vary the configuration of the dispensing openings in the toy. When the pet is first exposed to the invention, the dispensing openings can be aligned to allow the maximum size aperture through which treats are dispensed. As the pet manipulates the toy, the treats contained within will randomly cross the aperture and fall through to be eaten. Aligning the dispensing apertures to the maximum size increases the chance that treats will cross the aperture, thereby increasing the overall dispensing rate of the toy.

After the pet becomes proficient at dispensing treats, the dispensing openings can be adjusted to reduce the overall size of the opening or reconfigure the number of openings. The smaller opening reduces the probability that a treat will fall out of the toy and be dispensed to the pet, which therefore increases difficulty and duration of the challenge to the pet. As the pet's skill at dispensing treats from the toy increases, the user can make the dispensing opening(s) smaller to challenge the pet more.

As the pet manipulates the toy, treats inside the toy strike the inner wall of the toy and each other to generate aural stimulation. When the treats rattle inside the toy, crumbs fall off of the treats. Crumbs falling out of the toy would create an undesirable and potentially unsanitary mess that the user would need to clean. The toy substantially prevents crumbs from falling out of the toy as a pet plays with it by including relatively small filter apertures in the sidewall of the inner housing of the toy. These filter apertures allow crumbs to pass out of the inner housing, but the crumbs are trapped in the space between the inner housing and the outer housing. To further decrease the amount of crumbs that fall out of the toy, the toy optionally includes annular seals in the space between the inner and outer housings on either side of the dispensing opening. The filter apertures are preferably smaller in diameter than the average width of treats so that the treats themselves will not pass through the filter apertures and lodge themselves in the space between the housings. If the space between the inner and outer housings collect too many crumbs, the user can easily disassemble the housings and clean the crumbs from the space.

As the pet plays with the toy it receives auditory stimulation from the noise of the treat moving around inside the inner housing. The pet receives olfactory stimulation from the smell of the treat through the opening. Additional olfactory stimulation can be obtained by placing an aromatic object the inner housing. The size of the aromatic object should be sufficiently large so as to prevent its passage through the apertures but not so large as to prevent the free movement of the treat to be dispensed. The pet also receives tactile stimulation from the manipulation of the invention. The pet receives gustatory stimulation when it successfully manipulates the invention and the treat is dispensed through the opening, allowing the pet to eat the treat.

Although a toy according to the invention may be made from a variety of materials including, but not limited to, plastic, cardboard, and metal, additional visual stimulation is achieved by use of a transparent or translucent material. Utilizing transparent or translucent material allows the pet to visualize the treat contained within the toy, thereby visually stimulating the pet during play.

The foregoing general description and the following detailed description are exemplary and explanatory only and do not restrict the claims directed to the invention. The accompanying drawings, which are incorporated in and constitute a part of this specification, illustrate various exemplary embodiments of the toy and together with the description, serve to explain the principles of the invention.

### III. BRIEF DESCRIPTION OF THE DRAWINGS

FIG. 1 is a schematic perspective view of an exemplary version of the pet toy.

FIG. 1A is a schematic perspective view of the pet toy of FIG. 1 in which the inner and outer housings have been rotated relative to their respective positions shown in FIG. 1.

FIG. 1B is a schematic perspective view of the pet toy of FIG. 1 in which the inner and outer housings have been rotated relative to their respective positions more than the relative rotation shown in FIG. 1A.

FIG. 2 is a schematic perspective view of an inner housing of the pet toy shown in FIG. 1.

FIG. 3 is a schematic perspective view of an outer housing of the pet toy shown in FIG. 1.

FIG. 4A is a plan view of the end cap shown on the leftmost end of the pet toy shown in FIG. 1.

FIG. 4B is a cross-sectional elevation view of the end cap shown in FIG. 4A taken along the line 4B-4B shown in FIG. 4A.

FIG. 5A is a plan view of the end cap shown on the rightmost end of the pet toy shown in FIG. 1.

FIG. 5B is a cross-sectional elevation view of the end cap shown in FIG. 5A taken along the line 5B-5B shown in FIG. 5A.

FIG. 6 is a cross-section view of the pet toy shown in FIG. 1 and taken along the section line 6-6 of FIG. 1.

FIG. 7 is a cross-section view of a pet toy similar to the toy shown in FIG. 6, but with a rod positioned along the longitudinal axis of the toy and end caps adapted to hold the rod in the position shown.

FIG. 8 is a schematic perspective view of an alternative example of the pet toy.

FIG. 8A is a schematic cross section view taken along line 8A-8A in FIG. 8 with additional structures illustrated that are not shown in FIG. 8.

FIG. 9A is a schematic cross section view of the toy of FIG. 1 taken along line 9A-9A of FIG. 1 with additional dispensing apertures such that the user may selectively configure the toy to have one, two, or three dispensing openings.

FIG. 9B is a schematic cross section based on FIG. 9A but with the outer housing rotated relative to the inner housing to close partially all three dispensing openings.

FIG. 9C is a schematic cross section based on FIG. 9A but with the outer housing rotated relative to the inner housing to close completely all three dispensing openings.

FIG. 9D is a schematic cross section based on FIG. 9A but with the outer housing rotated relative to the inner housing such that the toy has only two dispensing openings.

### IV. DETAILED DESCRIPTION OF THE INVENTION

This application describes below exemplary embodiments of a toy according to the invention with reference to the accompanying drawings. Wherever possible, the application uses the same reference numbers throughout the drawings to refer to the same or similar items.

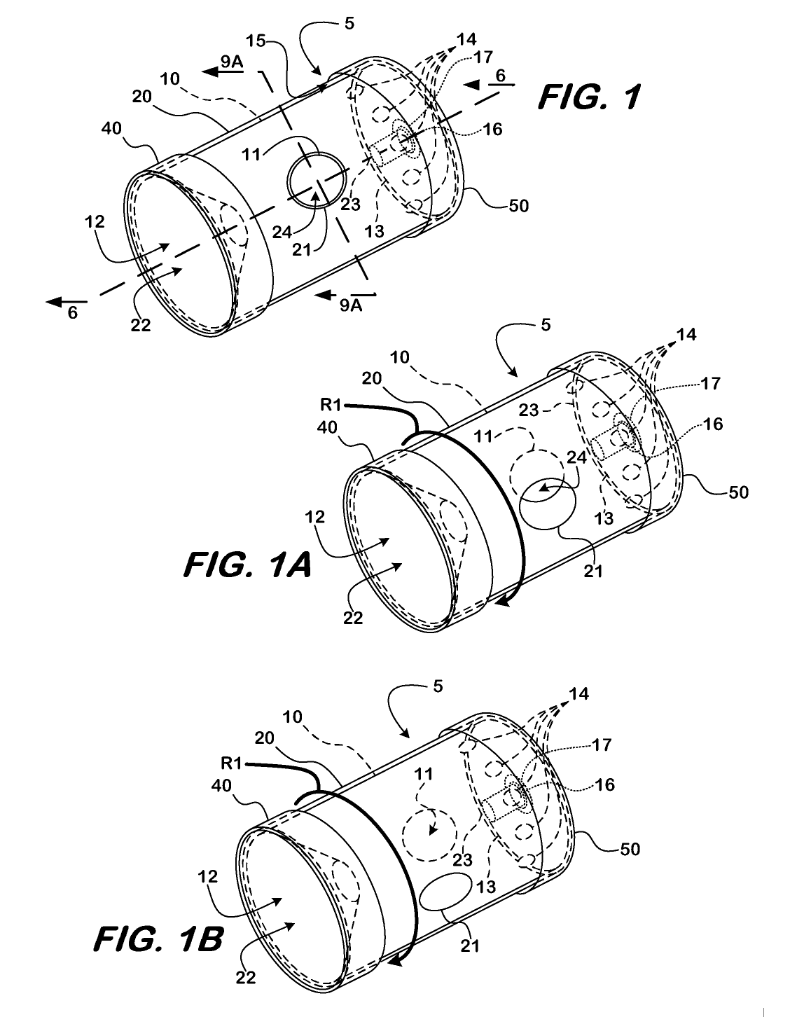

FIG. 1 is a schematic perspective view of the pet toy 5. Pet toy 5 includes a generally circular and cylindrical inner housing 10 that is nested inside an outer housing 20. End caps 40 and 50 cover opposing ends of the nested combination of inner housing 10 and outer housing 20. End cap 40 with wall 42 and aperture 41 is further illustrated in FIGS. 4A and 4B. The aperture 41 at the innermost edge of the wall 42 of end cap 40 allows easy insertion of treats into the toy. Additionally, the funnel shape of the end cap 40 reduces the probability that treats contained in the toy will spill out of the aperture 41 if the pet tips the toy upright onto the end cap 40. The illustrated aperture 41 is formed by at the innermost end of the wall 42. However, wall 42 may be fully conical with a closed apex and the aperture located in the wall 42 between the base and apex of the conical end cap. The funnel-shaped portion of the end cap 40 can be geometrically configured in a great number of ways. The shapes of end cap 40 defined at the cross-sections X-X and Y-Y of FIG. 4B may be any closed shape. As non-limiting examples, these cross sectional shapes may be a circle (the shape illustrated in the figures), an ellipse, a square, a triangle, a rectangle, or any other polygon. Preferably, the cross-sectional area of aperture 41 at section X-X is greater than or equal to the cross-sectional area of aperture 41 at section Y-Y.

End cap 50 with wall 52 is further illustrated in FIGS. 5A and 5B. The pet toy 5 includes a funnel-shaped end cap 40 covering the open end 12 of the inner housing 10 and the open end 22 of the outer housing 20. Wall 52 of end cap 50 covers closed end 13 of the inner housing 10 and closed end 23 of the outer housing 20. Each of closed ends 13 and 23 and cap 50 includes an aperture 16, all of which are approximately concentrically aligned to each other and into which a connector 17 may be inserted so that the housings 10 and 20 and cap 50 are rotationally connected to each other. Aperture 16 in closed end 13 is illustrated in FIGS. 1, 1A, 1B, 2, 6, 8, and 8A. Aperture 16 in closed end 23 is illustrated in FIGS. 1, 1A, 1B, 2, 3, 5A, 5B, and 6. Aperture 16 in cap 50 is illustrated in FIGS. 1, 1A, 1B, 5A, 5B, 6, 8, and 8A. Connector 17 is illustrated generically in FIGS. 1, 1A, 1B, 3, 5B, and 6 and may be any type of connector that will hold housings 10 and 20 in a relatively fixed position along their respective longitudinal axes while permitting the housings to rotate around those axes relative to each other. An example of such a connector is sold by ITW Fastex under the TUFLOK trademark. Housings 10 and 20 may alternatively be formed with an open end instead of closed ends 13 and 23 respectively. The inner housing 10 further includes a dispensing aperture 11 (see also FIG. 3), and outer housing 20 includes a complementary dispensing aperture 21. The dispensing apertures 11 and 21 are located such that they align with each other to form a dispensing opening when inner housing 10 and outer housing 20 are rotated to the positions shown in FIG. 1.

Dispensing aperture 11 is illustrated as being smaller than dispensing aperture 21. However, dispensing aperture 11 may be the same size as or larger than dispensing aperture 21. As treats inside the inner housing 10 crumble when a pet plays with the toy 5, the crumbs become statically charged and are caught in the space between inner housing 10 and outer housing 20. When apertures 11 and 21 are aligned as shown in FIG. 1, the size of the dispensing opening is its largest, which permits the contents of inner housing 10 to spill out at the maximum rate.

The user may control the effective size of the dispensing opening by rotating outer housing 20 relative to inner housing 10. For example, when the user rotates outer housing 20 in the direction labeled by arrow R1 as shown in FIG. 1A, the effective size of the dispensing opening is approximately one quarter of the maximum dispensing opening shown in FIG. 1. When the user rotates outer housing 20 further in direction R1, the dispensing opening is effectively closed so that the contents of inner housing 10 remain inside. Because inner housing 10 and outer housing 20 may be rotated to any relative position, the user may select any size for the dispensing opening between fully closed (shown in FIG. 1B) and fully open (shown in FIG. 1). Dispensing apertures 11 and 21 are shown as circular openings. Users may wish to adjust the size of the dispensing opening 24 to alter the challenge for their pets to extract a treat from inside the toy 5. Being able to change the difficulty of extracting a treat permits users to tailor the challenge to their own pets. Being able to change the size of dispensing opening 24 also permits users to adjust the difficulty of extracting a treat as their pets become more adept at extracting a treat from the toy 5. Other appropriate shapes for dispensing apertures 11 and 21 include at least oval, rectangular, triangular, trapezoidal, diamond, star, and teardrop, among others that would be apparent to a skilled artisan.

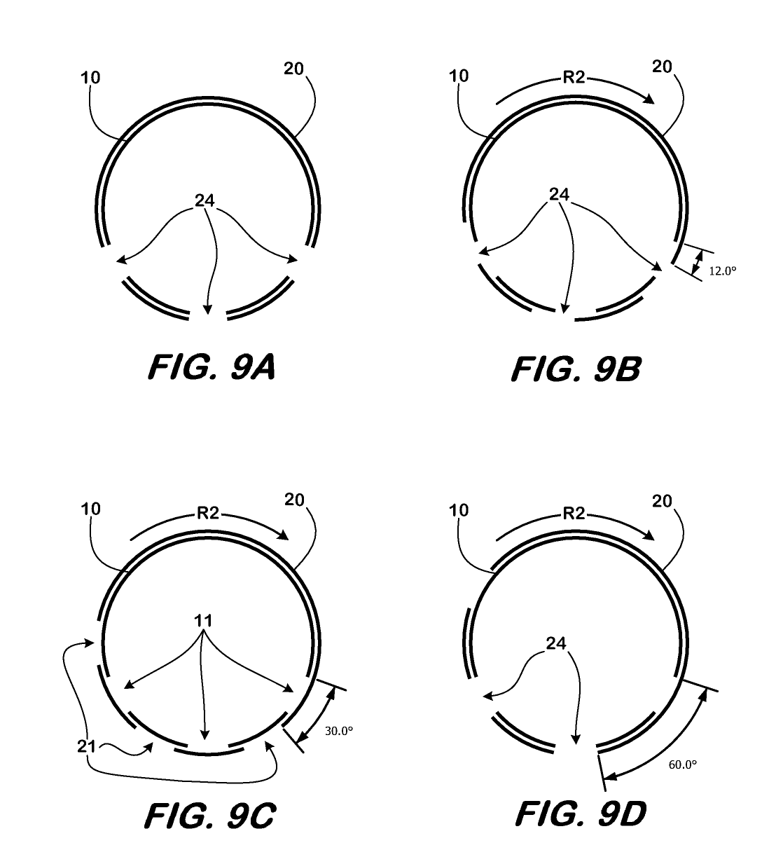

Inner housing 10 may include more than one dispensing aperture 11, and outer housing 20 may also include more than one dispensing aperture 21 to provide the user with added control over the effective size of the dispensing opening. For example, if inner housing 10 had two opposing dispensing apertures 11, and outer housing 20 had two opposing dispensing apertures 21, then the pet toy would be able to dispense treats through two opposing dispensing openings (if all the opposing pairs of dispensing apertures 11 and 21 were at least partially aligned). The dispensing apertures 11 and 21 may also be arranged so to permit the user to vary the number of dispensing openings, for example, between zero, one, two, and three. Such an arrangement is illustrated schematically in FIGS. 9A-D. FIG. 9A is a schematic cross section view taken along line 9A-9A of FIG. 1 and illustrates a pet toy in which each of the inner housing 10 and outer housing 20 have three dispensing openings 24 at locations 60° apart. The maximum area of the three dispensing openings 24 is illustrated in FIG. 9A. When outer housing 20 is rotated about 12° in direction R2 (as seen in FIG. 9B) relative to inner housing 10, the three dispensing openings 24 are about half of their maximum area. Rotating the outer housing 20 in direction R2 by about 30° from the starting position in FIG. 9A results in all three dispensing openings 24 being closed because none of the dispensing apertures 11 overlap any of the dispensing apertures 21. Rotating the outer housing 20 in direction R2 by about 180° similarly results in all three dispensing openings 24 being closed. When outer housing 20 is rotated about 60° from the starting position in FIG. 9A, only two dispensing openings 24 are present and they are open at their maximum size.

Although any material such as plastic, cardboard, metal, etc. will suffice, additional benefit is gained by using sufficiently optically transparent material in the inner housing 10 and outer housing 20 so that the pet can see the treat contained in the inner housing. Allowing the pet to see the treat provides additional optical stimulation for the pet. The housing material may have static-enhancing additives to increase the electrostatic charge between the housings and thereby trap the debris. Additionally the embodiment may have a seal material on the interior of the outer housing 20 around the outer housing dispensing aperture 21. The seal material prevents debris trapped between the two housings from escaping. The embodiment may also have raised rims or lips around the dispensing apertures 11 and 21 to further prevent debris from escaping.

An embodiment of the invention may utilize triangle shaped dispensing apertures 11, 21 in the inner and outer housing. The dispensing aperture 11 in the inner housing 10 is aligned as a reversed or mirror image of the dispensing aperture 21 in the outer housing 20. Thus, as the housings 10, 20 are positioned to align the apertures 11, 21 the apexes are aligned first, followed by increasing areas of the triangle shaped apertures. The size of the opening can be precisely controlled by limiting the amount of overlap between the aligned apertures.

Another embodiment utilizes a single large dispensing aperture 21 on the outer housing 20 and a linear configuration of various sized apertures 11 in the inner housing 10. The size of the opening is determined by aligning the dispensing aperture 21 in the outer housing 20 with the desired size dispensing aperture 11 in the inner housing 10.

FIGS. 1A-1B are schematic perspective views of pet toy 5 that illustrate how outer housing 20 may be rotated around inner housing 10 to alter the size of the opening in the sidewall of pet toy 5.

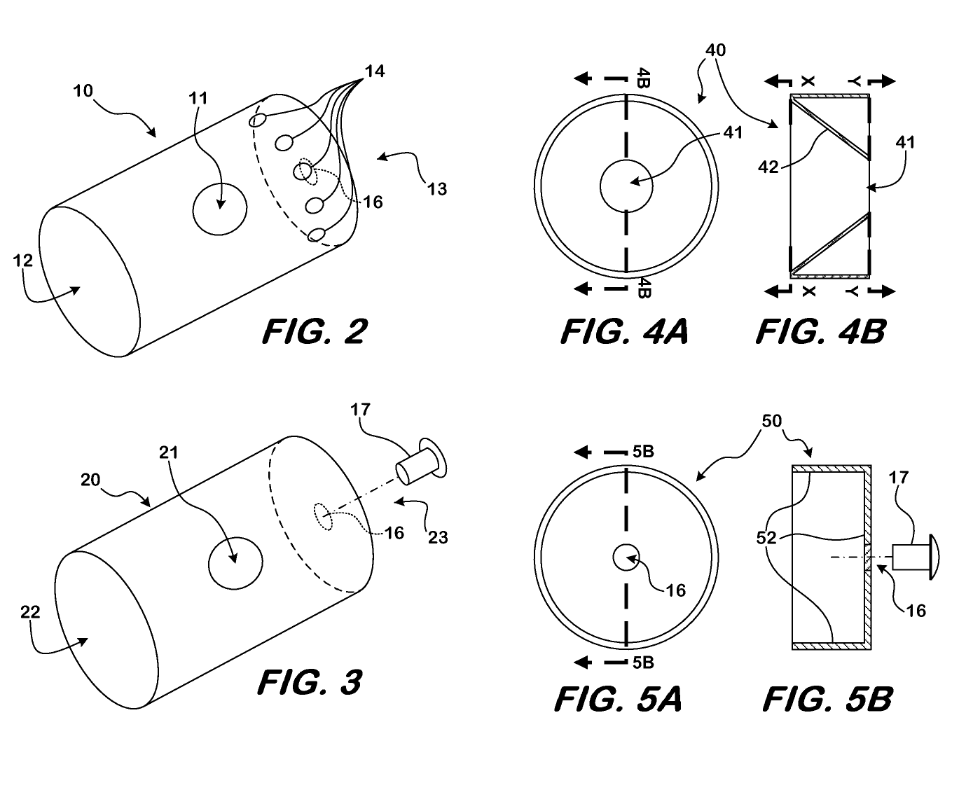

FIG. 2 is a perspective view of an inner housing. The wall structure 10 shown is cylindrical, although in some embodiments the structure may be spherical, polyhedral, etc. Nearly any material may be used for the wall structure 10, however use of transparent or partially transparent material provides visual stimulation to the pet by allowing the pet to see the treat contained in the toy. The inner housing wall structure 10 preferably has one open end 12 and one closed end 13. The dispensing aperture 11 shown is oval, although any other shape such as triangular, square, teardrop, etc. will suffice. An embodiment of the inner housing may have a series of apertures of varying sizes rather than the single aperture 11. The inner housing wall structure 10 may also contain smaller filter apertures 14 sized such that a contained treat cannot pass through the filter apertures 14 but debris and other smaller particles can pass through the filter apertures 14. Alternatively, closed end 13 may be an open end similar to open end 12. In such an alternative arrangement, inner wall 52 of cap 50 encloses the end 13 of housing 10.

FIG. 3 is a perspective view of the outer housing 20. The outer housing 20 wall structure shown is cylindrical, although in some embodiments the structure may be spherical, polyhedral, etc, so long as the shape allows the outer housing to partially or completely enclose the inner housing. The outer housing 20 may be formed of nearly any material. However, use of transparent or translucent material in conjunction with a transparent or translucent inner housing increases visual stimulation to the pet by allowing the pet to see the treat contained in the toy. The outer housing 20 wall structure has one or more open ends, 22, 23 to allow insertion of the inner housing. The outer housing 20 as shown has an oval dispensing aperture 21, although any shape such as triangular, square, teardrop, etc. will suffice. Alternatively, closed end 23 may be an open end similar to open end 22. In such an alternative arrangement, inner wall 52 of cap 50 encloses the end 23 of housing 20.

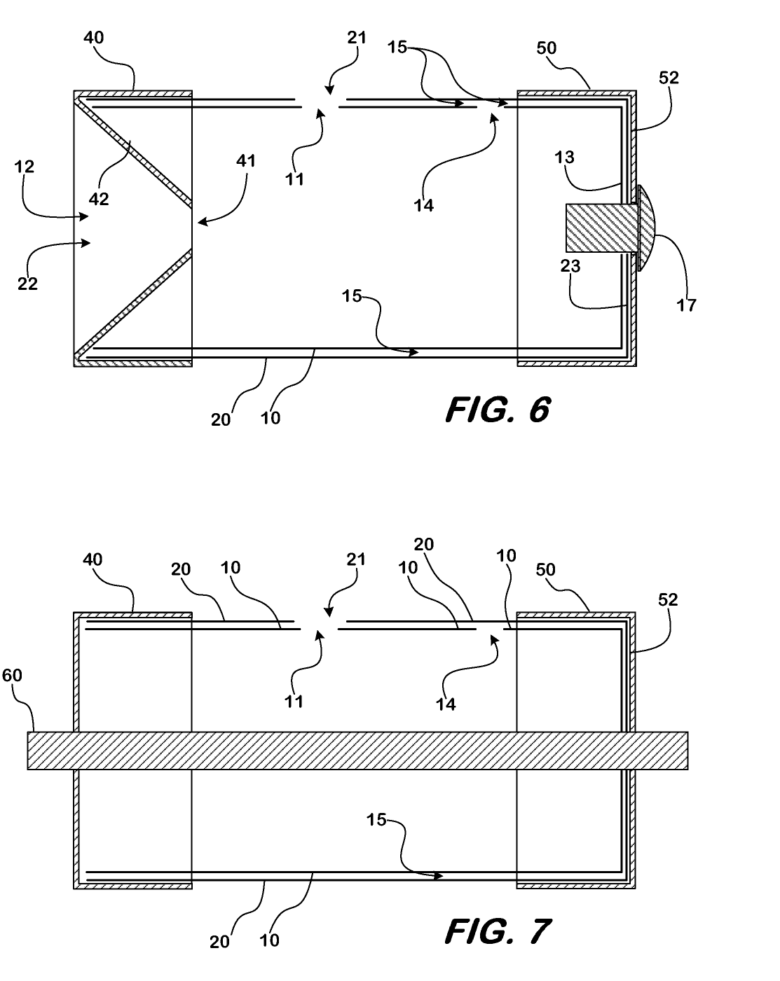

FIG. 6 is a cross-sectional view along the toy's longitudinal axis taken along line 6-6 of FIG. 1. The pet toy 5 includes filter apertures 14 in inner housing 10, which allow small particles and dust from the contents to exit inner housing 10 and become trapped in the space 15 between inner housing 10 and outer housing 20. The pet toy therefore collects in space 15 much of the dust and particles that fall off of the contents inside the pet toy, which prevents these particles and dust from soiling the floor or carpeting on which a pet plays with the toy. To maximize the dust collecting capability of pet toy 5, inner housing 10 and outer housing are preferably made of plastic (e.g., cellulose propionate, PETG polyester, PVC, and other clear plastic materials that are statically chargeable).

FIG. 7 is a cross-sectional view of the toy with a mounting device installed. The rod 60 is inserted axially through the inner housing 10 and outer housing 20 such that the toy may rotate around the rod 60. In this embodiment, the rod 60 allows users to mount the toy to chair supports, walls, and other objects. As the pet manipulates the toy, the toy rotates around the rod 60 and treats will be dispensed the treats align with the dispensing apertures. This embodiment restricts the location of the toy to the predetermined mounting location. Any crumbs or other debris that escape through the dispensing aperture will be confined to the mounting area, thereby simplifying collection and clean up.

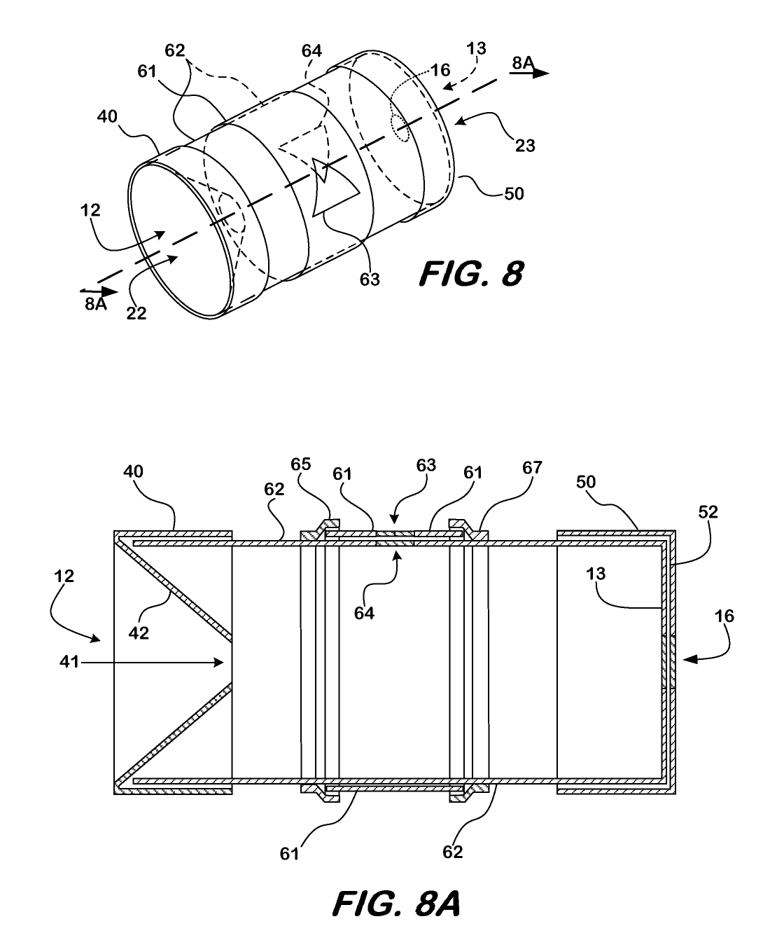

FIG. 8 is a perspective view of an embodiment of the invention which utilizes an outer cover 61 and a cylindrical housing 62. Although the housing 62 shown is cylindrical, any shape which will contain treats will suffice. The outer cover 61 is movably connected to the cylindrical housing 62 using retention rings 65 and 67 (illustrated only in FIG. 8A) such that the outer cover dispensing aperture 63 may be at least partially aligned with the cylindrical housing dispensing aperture 64. Although the dispensing aperture 63 and dispensing aperture 64 are shown as triangular, any shape such as circular, ovoid, rectangular, teardrop, etc. will work. The method of operation for the embodiment shown in FIG. 8 is the similar to the method of operation for the embodiment shown in FIGS. 1, 1A, and 1B. The outer cover 61 is rotated such that the dispensing aperture 63 at least partially aligns with the cylindrical housing dispensing aperture 64. By altering the alignment between dispensing aperture 63 and dispensing aperture 64 a pass-through dispensing aperture is created. By decreasing the size of the pass-through dispensing aperture, the probability that a treat will randomly align and be dispensed is correspondingly decreased. As the probability of dispensing decreases the challenge to manipulate the toy and dispense treats increases, providing a more stimulating challenge to the pet.

The outer cover 61, which does not extend the entire length of the housing 62, is held in place around housing 62, for example, by retention rings 65 and 67 (see FIG. 8A). Retention rings 65, 67 would be fixed in relation to housing 62 and permit cover 61 to slide relative to retention rings 65, 67 and housing 62. Alternatively, outer cover 61 may be held in place around housing 62 using retention tabs (not illustrated), which would be connected to housing 62 in positions distributed around the perimeter of outer cover 61. The outer cover 61 may or may not contain dispensing apertures 63 to align with the housing dispensing aperture 64. If no dispensing aperture 63 is included in the outer cover 61, the opening size is controlled by positioning the outer cover 61 such that it partially obstructs the dispensing aperture 64 on the housing 62. If a dispensing aperture 63 is included, the opening size may be controlled either by partially obstructing the dispensing aperture 64 on the housing 62 or by partially aligning the outer cover dispensing aperture 63 with the housing dispensing aperture 64.

It will be apparent to those skilled in the art that various modifications and variations can be made in the embodiments of a toy according to the invention and methods of making such a toy that are described above without departing from the scope or spirit of the invention. Therefore, other embodiments of the invention will be apparent to those skilled in the art from their consideration of the specification and practice of the invention disclosed above. The applicant intends that the specification and examples be considered as exemplary only, with the true scope and spirit of the invention being indicated by the following claims.

What is claimed is:

1. A pet toy, comprising:
A. an inner housing that:
i. comprises:
a. an inner sidewall,
b. at least one inner dispensing aperture in the inner sidewall, and
ii. defines at least one inner open end; and
B. a cover movably connected to the inner housing and comprising:
i. an outer sidewall, and
ii. at least one outer dispensing aperture in the outer sidewall; and in which:
C. the cover may be moved relative to the inner housing into a first dispensing position in which the inner dispensing aperture at least partially overlaps the outer dispensing aperture to form a dispensing opening; and
D. the cover may be moved relative to the inner housing into a closed position in which the inner dispensing aperture does not at least partially overlap the outer dispensing aperture.

2. The pet toy of claim 1, in which the inner dispensing aperture is no larger than the outer dispensing aperture.

3. The pet toy of claim 1, in which the outer sidewall:
A. extends substantially the entire length of the inner housing and
B. defines an outer housing having at least one outer open end.

4. The pet toy of claim 3, further comprising a first end cap covering the inner open end and the outer open end that includes a filling aperture.

5. The pet toy of claim 4, in which:
A. the first end cap comprises a funnel-shaped portion having an end cap wall that protrudes into the interior and
B. the filling aperture is located in the end cap wall.

6. The pet toy of claim 5, in which the first end cap comprises a funnel-shaped portion having an end cap wall that:
A. protrudes into the interior and
B. defines a filling aperture.

7. The pet toy of claim 6, in which the filling aperture has:
A. a first cross-sectional area in a first plane that is:
i. perpendicular to the longitudinal axis of the toy and
ii. located at the outermost end of the first end cap;
B. a second cross-sectional area in a second plane that is:
i. perpendicular to the longitudinal axis of the toy and
ii. located at the innermost end of the first end cap; and
C. the first cross-sectional area is greater than or equal to the second cross-sectional area.

8. The pet toy of claim 7, in which the filling aperture is located at an innermost end of the funnel-shaped portion.

9. The pet toy of claim 8, in which the funnel-shaped portion is a frustum.

10. The pet toy of claim 9, in which the funnel-shaped portion is a conical frustum, a pyramidal frustum, a spherical frustum, a parabolic frustum, a hyperbolic frustum, an oblate spheroid frustum, or a prolate spheroid frustum.

11. The pet toy of claim 3, in which the inner housing further comprises a filter aperture in the inner sidewall that cannot be aligned with the outer dispensing aperture.

12. The pet toy of claim 11, in which the filter aperture no larger than the inner dispensing aperture.

13. The pet toy of claim 3, in which the outer sidewall is circularly cylindrical.

14. The pet toy of claim 13, in which the inner sidewall is circularly cylindrical.

15. The pet toy of claim 14, in which:
A. the inner housing further comprises an inner end wall opposite the inner open end;
B. the outer housing further comprises:
i. an outer end wall opposite the outer open end and near the inner end wall and
ii. an outer connecting hole in the outer end wall; and
C. further comprising a connector that:
i. is inserted through the outer connecting hole,
ii. is attached to the inner end wall, and
iii. permits the inner housing and the outer housing to rotate relative to each other and prevents the inner housing and outer housing from moving in a longitudinal direction relative to each other.

16. The pet toy of claim 15, in which:
A. the inner end wall further comprises an inner connecting hole that is approximately aligned with the outer connecting hole; and
B. the connector is inserted through the inner connecting hole.

17. The pet toy of claim 4, in which:
A. the outer housing further defines an outer end opposite the outer open end and
B. the toy further comprises a second end cap connected to the outer housing and covering the outer end.

18. The pet toy of claim 17, in which:
A. the inner housing further comprises an inner end wall opposite the inner open end;
B. the outer housing further comprises:
i. an outer end wall opposite the outer open end and near the inner end wall and
ii. an outer connecting hole in the outer end wall; and
C. further comprising a connector that:
i. is inserted through the outer connecting hole,
ii. is attached to the inner end wall, and
iii. permits the inner housing and the outer housing to rotate relative to each other and prevents the inner housing and outer housing from moving in a longitudinal direction relative to each other.

19. The pet toy of claim 11, further comprising a seal positioned in the space between the inner housing and the outer housing and between the inner dispensing aperture and the filter aperture.

20. The pet toy of claim 1, further comprising:
A. a second inner dispensing aperture in the inner sidewall and spaced apart from the inner dispensing aperture;
B. a second outer dispensing aperture in the cover and spaced apart from the outer dispensing aperture, and in which:
i. when the cover is in the first dispensing position, the second outer dispensing aperture at least partially overlaps the second inner dispensing aperture to form a second dispensing opening, and
ii. the cover may be moved to a second dispensing position relative to the inner housing in which:
a. the second outer dispensing aperture at least partially overlaps the inner dispensing aperture,
b. the outer dispensing aperture does not at least partially overlap any of the inner dispensing aperture and the second inner dispensing aperture; and
iii. when the cover is in the closed position, none of the outer dispensing aperture, the second outer dispensing aperture, and the third outer dispensing aperture overlaps any of the inner dispensing aperture, the second inner dispensing aperture, and the third inner dispensing aperture.

21. The pet toy of claim 1, further comprising:
A. a second inner dispensing aperture in the inner sidewall and spaced apart from the inner dispensing aperture;
B. a second outer dispensing aperture in the cover and spaced apart from the outer dispensing aperture, such that:
C. a third inner dispensing aperture in the inner sidewall and spaced apart from the inner dispensing aperture and the second inner dispensing aperture;
D. a third outer dispensing aperture in the cover and spaced apart from the outer dispensing aperture and the second outer dispensing aperture, and in which:
i. when the cover is in the first dispensing position,
a. the second outer dispensing aperture at least partially overlaps the second inner dispensing aperture to form a second dispensing opening, and
b. the third outer dispensing aperture at least partially overlaps the third inner dispensing aperture to form a third dispensing opening,
ii. the cover may be moved to a second dispensing position relative to the inner housing in which:
a. the third outer dispensing aperture at least partially overlaps the second inner dispensing aperture,
b. the second outer dispensing aperture at least partially overlaps the inner dispensing aperture, and
c. the outer dispensing aperture does not at least partially overlap any of:
(1) the inner dispensing aperture,
(2) the second inner dispensing aperture, and
(3) the third inner dispensing aperture;
iii. the cover may be moved to a third dispensing position relative to the inner housing in which:
a. the third outer dispensing aperture at least partially overlaps the inner dispensing aperture,
b. none of the second outer dispensing aperture and the outer dispensing aperture at least partially overlap any of:
(1) the inner dispensing aperture,
(2) the second inner dispensing aperture, and
(3) the third dispensing aperture; and
iv. when the cover is in the closed position, none of the outer dispensing aperture, the second outer dispensing aperture, and the third outer dispensing aperture overlaps any of the inner dispensing aperture, the second inner dispensing aperture, and the third inner dispensing aperture.

22. A pet toy, comprising:
A. means for containing a plurality of items of interest to a pet;
B. means for permitting the containing means to be filled with the plurality of items;
C. means for selectively altering the probability that any of the plurality of items to spill out of the toy when a pet plays with the toy;
D. means for substantially preventing debris generated by partial disintegration of the plurality of items from spilling out of the toy.
